(19) United States
(12) Patent Application Publication
(10) Pub. No.: US 2002/0059166 A1
(43) Pub. Date: May 16, 2002

(54) Method and system for extracting contents of web pages

(75) Inventors: Douglas W. Wang, Hsinchu (TW); Chan-Shiun Wu, Changhua (TW); Wei-Shang Chen, Taichung (TW); Peng-Cheng Lai, Taipei (TW)

Correspondence Address: BAKER & BOTTS, 30 ROCKEFELLER PLAZA, NEW YORK, NY, 10112

(73) Assignee: WAYTECH DEVELOPMENT INC

(21) Appl. No.: 09/758,936

(22) Filed: Jan. 11, 2001

(30) Foreign Application Priority Data
Nov. 2, 2000 (TW) 89123143

(51) Int. Cl. G06F 7/00

(52) U.S. Cl. 707/1

(57) ABSTRACT

A method and system for automatically parsing codes of Web pages and extracting contents of the Web pages. A computer program is utilized to decompose Web pages into a plurality of content blocks for users to flexibly select some desired content blocks according to their preferences and needs. Save a selection setting of the selected content blocks of Web pages and transmit the setting and the selected contents of Web pages to portable data processing gismos. Users thus could use portable data processing gismos to browse the information over the Internet and even use the selection setting to update the instant information of Web pages.

### FIELD OF THE INVENTION

This invention relates to a method and system for extracting contents of Web pages, and specifically relates to a method and system for extracting contents of Web pages according to the requirement of a user's preference. The present invention further breaks through the hardware limitation of portable data processing gismos, such as desktops, laptops, palm tops, personal digital assistants (PDA), pocket PCs or mobile phones, etc., so that users would instantly update the information from the Internet more flexible than ever before.

### BACKGROUND OF THE INVENTION

Internet technology is changing the way people live and the development of e-commerce further imposes the trend of changing. Traditionally, the information providers of the cyberspace, such as the mass media involving the field of e-commerce, often utilize application servers coupled with the Internet to broadcast messages to their subscribers through the Internet. The net information providers should periodically invest lots of resources to maintain and renew the information on the Internet. However, the broadcasting of message release on the Internet may be inefficient in information communication, thus wasting resources for e-companies and clients because the e-companies indiscriminately broadcast the same messages to all the clients, disregarding their real needs. To some clients, the messages received from the e-company could be too simple, while to the others they could be redundant. For example, the web pages broadcast by content providers, such as mass media, may include articles, graphics, advertisements and surveys, etc. Some are only interested in parts of the articles, and feel bothered by the pictures and advertisements. For some clients, when they browse Web pages, they may be only interested in parts of the articles of one Web page and further look for more details of next Web page. It would take lots of time to retrieve the whole contents of the new Web page, while including some other unnecessary contents for them. It's obvious the current information distribution system on the Internet lacks flexibility to sufficiently meet each user's needs.

On the other hand, another drawback of the prior art is the limited capability of browsing the Web page using portable data processing gismos. This is because the size of screens and the volume of memory resources of portable data processing gismos are too small to access a normal Web page, which is applicable to personal computers.

In order to solve the problem for portable data processing gismos described above, one of the prior art methods is that users of portable data processing gismos utilize a browser to browse, in a fixed pattern, Web pages one by one. Besides, for different Web page, users must respectively log on different page addresses to download the contents thereof every time rather than to download them all in sequence for one time. It's obvious that this method is also time-consuming. The second method is that the Web page providers, such as the mass media, follow the page specifications, establishing by the e-companies for broadcasting messages on the Internet, to design specific versions of the Web pages for the users browsing on portable data processing gismos. Yet, this method of redesigning and renewing specific Web pages for the Web page providers is not only time-consuming but also unprofitable. Accordingly, there are just a few Web page providers doing so. The users of portable data processing gismos certainly do not satisfy about this method. Another method is, traditionally, software developers design one kind of plug-in filter, a computer software program installed in application servers or personal computers for parsing the contents of Web pages to extract desired contents thereof without any unnecessary advertisements, graphics, etc. However, according to this method the contents extracted depend on the subjective choices of those software developers but not clients themselves. Moreover, it also takes time and labors to construct filters respectively for different Web pages.

Accordingly, there is a need to improve the method and the system of Internet messages release technology described above for clients to retrieve messages from the Internet more flexible and to improve the efficiency of messages transmission over the Internet. Moreover, under the current architecture of cyberspace, improving the method and the system to access resources of cyberspace more flexible for portable data processing gismos is also crucial.

### SUMMARY OF THE INVENTION

It is therefore an object of the present invention to provide a method and system for retrieving flexibly messages and services of the cyberspace between client terminals and application servers through the Internet.

It is another object of the present invention to provide a computer implemented method and a computer program product for parsing the contents of Web pages and decomposing the whole contents into several content blocks. Then, transmit those content blocks sequentially to the application server to provide client terminals flexibly constructing a setup with desired formats for retrieving information of the cyberspace.

The present invention discloses a method and system for automatically parsing the contents of Web page and decomposing the whole contents into several content blocks. The user could individually and flexibly extract any blocks, he desires, from the Web pages of each Web site and further set up the architecture of retrieving the information of the cyberspace for portable data processing gismos. In another word, the user could extract the contents of Web pages according to his preferences without passively receiving a plurality of unnecessary information and thus promote the efficiency and the usage of computers and the like. As a result, the present invention relieves the traditional Web page providers of the burden to design specific versions of the Web pages for portable data processing gismos and also solves the problem of insufficiency about the bandwidth and the memory resource when transmitting data to portable data processing gismos. Meanwhile, because the application server have already extracted the whole contents of web pages, which the clients terminals desires, the time for searching and downloading the contents of one Web page by one Web page could accordingly be saved.

### BRIEF DESCRIPTION OF THE DRAWINGS

For a more complete understanding of the invention, references are made to the following Detailed Description of the Preferred Embodiment taken in connection with the accompanying drawings in which:

FIG. 1 is functional block diagram illustrating a Web page extracting system of the present invention;

FIG. 2 is functional block diagram illustrating the functions of the Web page extracting system of the present invention;

FIG. 3 is a flow chart embodying the Web page extracting system of the present invention;

FIG. 4 is an embodiment of the Web page extracting system of the present invention;

FIG. 5 is an embodiment of the Web page extracting system of the present invention;

FIG. 6 shows an embodiment of a web-site database of the Web page extracting system of the present invention; and

FIG. 7 shows an embodiment of a web-site database of the Web page extracting system of the present invention.

### DETAILED DESCRIPTION OF THE PREFERRED EMBODIMENT

The present invention discloses a method and system for extracting the contents of Web pages by means of decomposing the contents into several content blocks. The user could parse the codes, programmed by specific program languages, of Web pages and then decompose the contents thereof into several content blocks and extract the blocks flexibly according to his needs and preferences. Moreover, the user could set up individually the architecture of retrieving the information of any Web page on the cyberspace to avoid stuffing lots of redundant messages with memories of user's receiving means as well as transmission channels over the cyberspace. The present invention is specifically applicable to portable data processing gismos, such as desktops, laptops, palm tops, personal digital assistants (PDA), pocket PCs or mobile phones and the like to construct the architecture of retrieving net information. The present invention solves disadvantages of the prior art that Web pages providers should require lots of labors and resources to redesign the Web pages, originally applicable to person computers, to meet the specifications for portable data processing gismos. The main spirits of the present invention will be illustrated as below. Subsequently, an example will be introduced to show a practical implementation of the invention on a PDA.

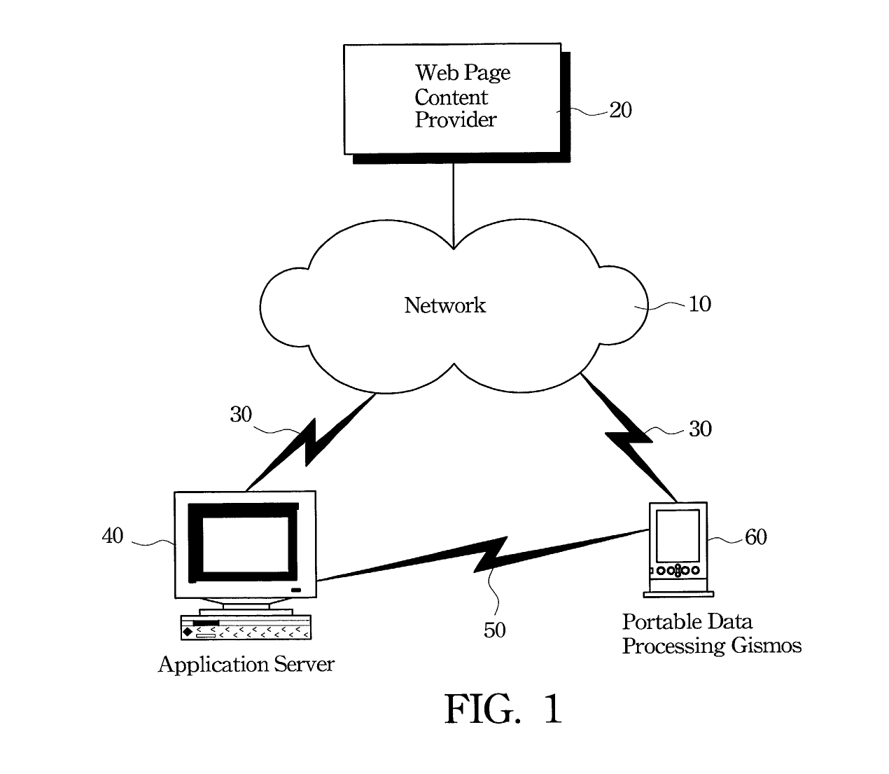

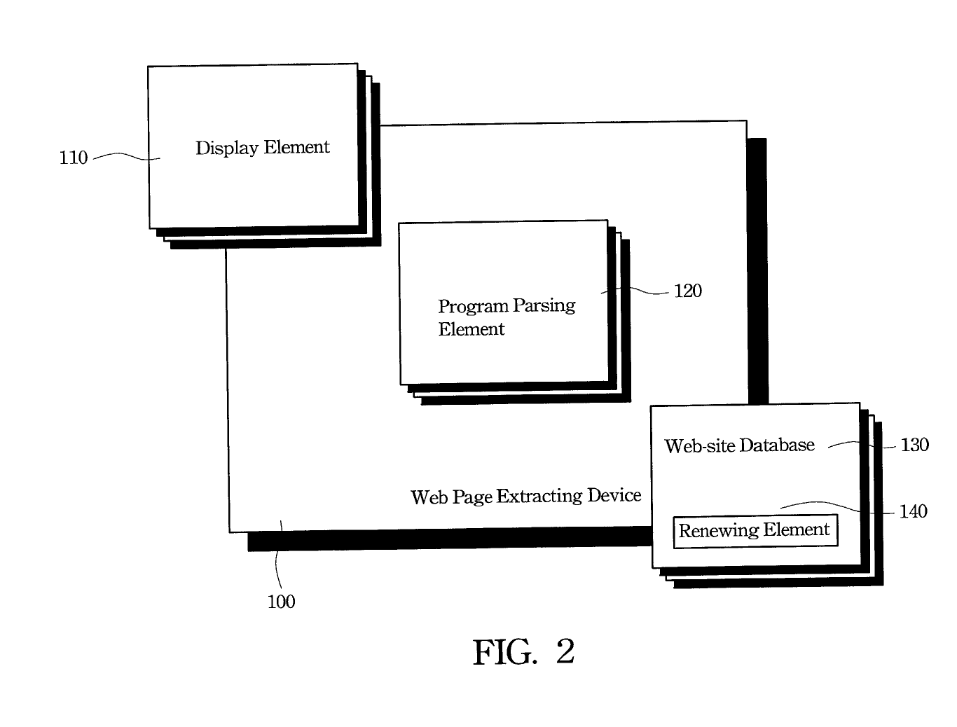

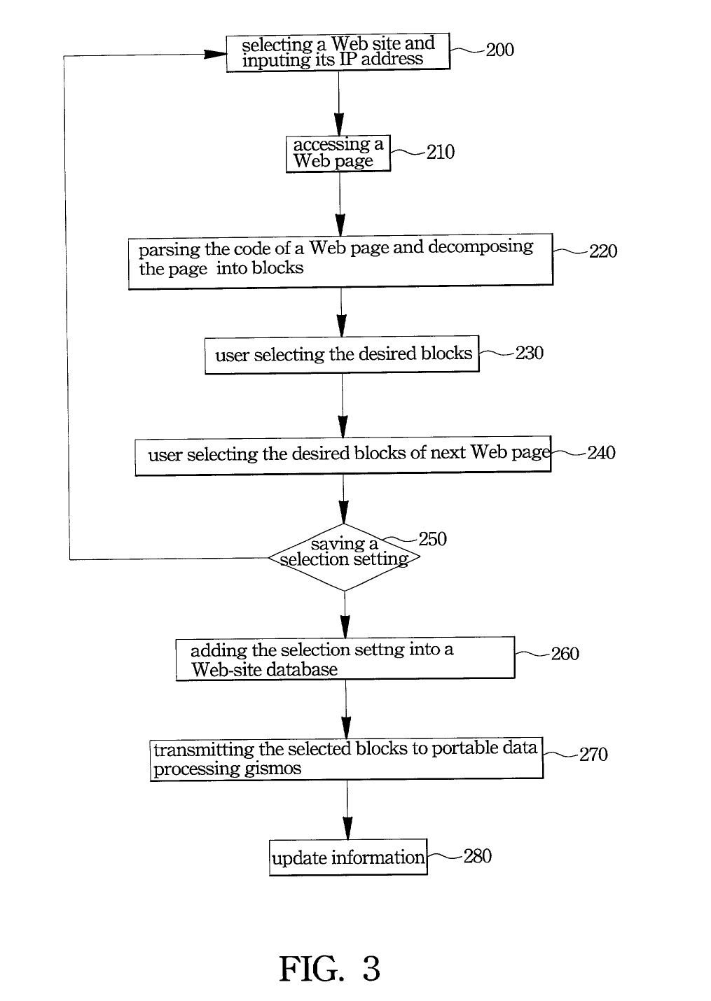

Referring to FIG. 1, the present Web page extracting system includes a Web page content provider 20, an application server 40, a portable data processing device 60 over a network 10, a first connection means 30 and a second connection means 50. Each application server 40 represents a node on the Internet, which could be embodied as an Internet accessible apparatus, such as a computer workstation, personal computer. The Web page content provider 20 denotes one of media companies unilaterally broadcasting Web pages, generally applicable to the application server 40, over the network 10. The contents of these Web pages often include different kinds of articles, graphics, advertisements and surveys, etc., to fulfill requirements of online clients. The application server 40 of the present invention could flexibly extract the contents of Web pages provided by the Web page content provider 20 on the Internet. The first connection means 30 and the second connection means 50 are coupled with the Internet, by wire or wireless. The method of the invention is illustrated as below with referring to FIG. 2 and FIG. 3.

A Web page extracting device 100, as shown in FIG. 2, is installed in the application server 40. The Web page extracting device 100 includes a display element 110, a program parsing element 120 and a Web-site database 130. Referring to the step 200 of FIG. 3, utilize the application server 40 to choose and log on a Web site by inputting its IP address or domain name first. Then, access a Web page provided by the Web page content provider 20, as shown in the step 210, via the first connection means 30 coupled with the Internet, by wire or wireless, and show the Web page on the display element 110, such as a display window, of the Web page extracting device 100. The Web page extracting device 100 utilizes the program parsing element 120 to parse the architecture of the program code of the Web page and automatically to decompose the Web page into several content blocks, as shown in the step 220. Subsequently, the user would select some desired content blocks from all of them according to the user's preferences and needs, as shown in the step 230. If the content blocks of the Web page further include a sub-layer data structure and the user is interested in parts of the content blocks, then the user would select one of the blocks, he desires, and click to enter next Web page of the sub-layer data structure and looking for the more details. Meanwhile, the program parsing element 120 would similarly keep decomposing the sub-layer Web page into the other plural content blocks for the user to select some, as shown in the step 240. Once the preserving content blocks of a Web page have been selected, save the selections of the Web page, as shown in the step 250. After the contents of all Web pages of the web sites have been selected, save the selection setting of Web pages in the Web-site database 130, as shown in the step 260.

Users could repeat to utilize the method of the invention as mentioned above, on any Web site of the network 10 and according to users' needs and preferences to extract the contents of Web pages of one Web site. More specifically, the program parsing element 120 is use to parse the architecture of codes, programmed by specific program languages, of Web pages. Generally, the program languages are in forms of CGI programs, Active Server Pages, JAVA programs, HTML programs, XML programs and the like. For HTML programs as an example, the program parsing element 120 parses the architecture of a code of a Web page, programmed by HTML programs, and decomposes the main body of the HTML code, i.e., between <Body> and </Body>, the tables of the HTML code, i.e., between <Table> and </Table>, as well as the other parts between the main body and the tables of the HTML code into a plurality of program blocks. Specially, each of the program blocks of a code is correlative to each of the content blocks of a Web page. Moreover, assign one corresponding index to each program block of the program code to facilitate the updating of the contents of Web pages.

The Web-site database 130 of the invention further includes a renewing element 140 for users to update their Web site contents. That is to utilize the renewing element 140 accompanying with the saved selections of the preserving content blocks of a Web page to update the contents of each preserving block of each Web page in the Web-site database 130 from each Web page content provider 20 via the first connection means 30. Therefore, users could efficiently retrieve their necessary information to prevent wasting lots of time to retrieve redundant messages. Besides, users could also save their costs of retrieving net information and solve the problem of insufficiency of net bandwidth and the phenomenon of “netjams.”

Similarly, The method and system of the present invention is applicable to portable data processing gismos 60, such as desktops, laptops, palm tops, personal digital assistants (PDA), pocket PCs, mobile phones or the like for browsing Web pages, as shown in FIG. 1. Generally, compared portable data processing gismos 60 with personal computers, the volume of memory resources of the portable data processing gismos 60 is smaller than that of the personal computers. Besides, screens of portable data processing gismos 60 are also smaller. Traditionally, it is hard to use portable data processing gismos 60 to browse Web pages on the Internet 10. As shown in the step 270 of FIG. 3, the present invention would solve the above-mention problem by means of transmitting the Web-site database 130 in sequence to the portable data processing gismos 60 via the second connection means 50. The portable data processing gismos 60 therefore could browse the preserving content blocks of Web pages directly because the data are smaller after decomposing and extracting.

If users wish to update the contents of the preserving content blocks of each Web page saved in the portable data processing gismos 60, as shown in the step 280, there would be two ways of updating. The first one utilizes the renewing element 140 of the Web page extracting device 100 in the application server 40 to update the contents of the preserving content blocks of each Web page, saved in the portable data processing gismos 60, via the first connection means 30 coupled with the network 10. The second method utilizes the renewing element 140 of the Web-site database 130 in the portable data processing gismos 60, such as PDA, accompanying with the saved selections of the preserving content blocks of each Web page to update the contents thereof each Web page content provider 20 via the first connection means 30. As a result, the traditional Web page content providers don't have to spend lots of resources to redesign the Web pages to meet the specification version for portable data processing gismos. The user of portable data processing gismos can also flexibly and instantly access information of the cyberspace.

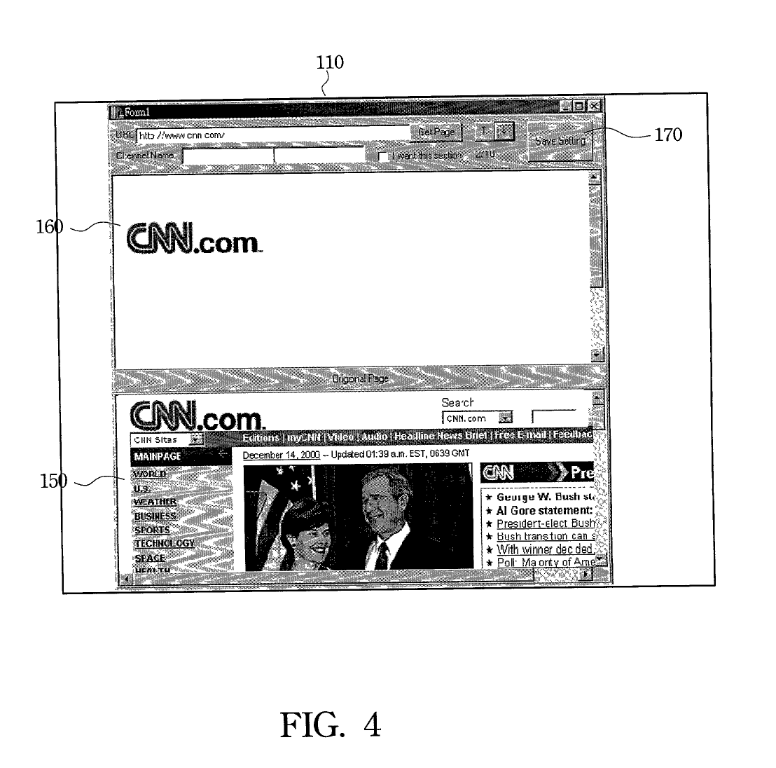

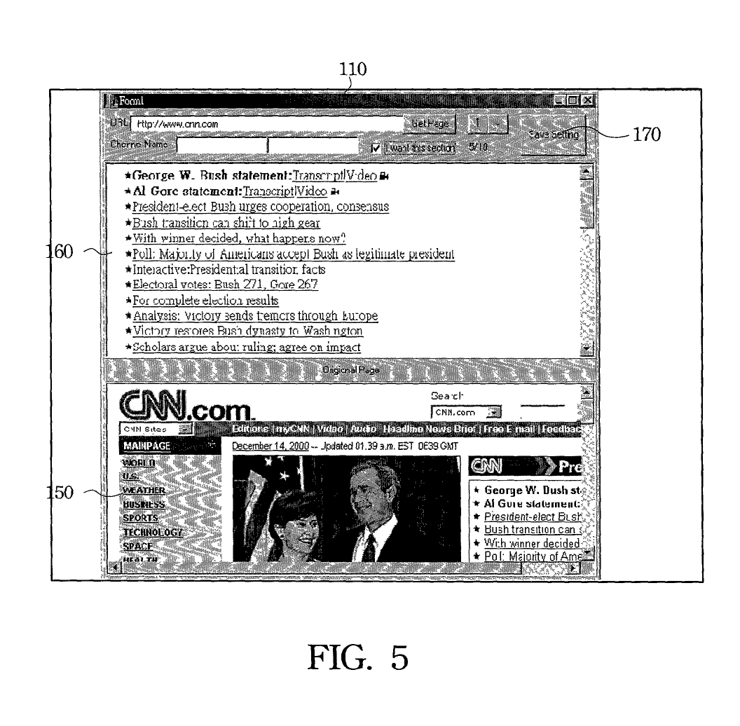

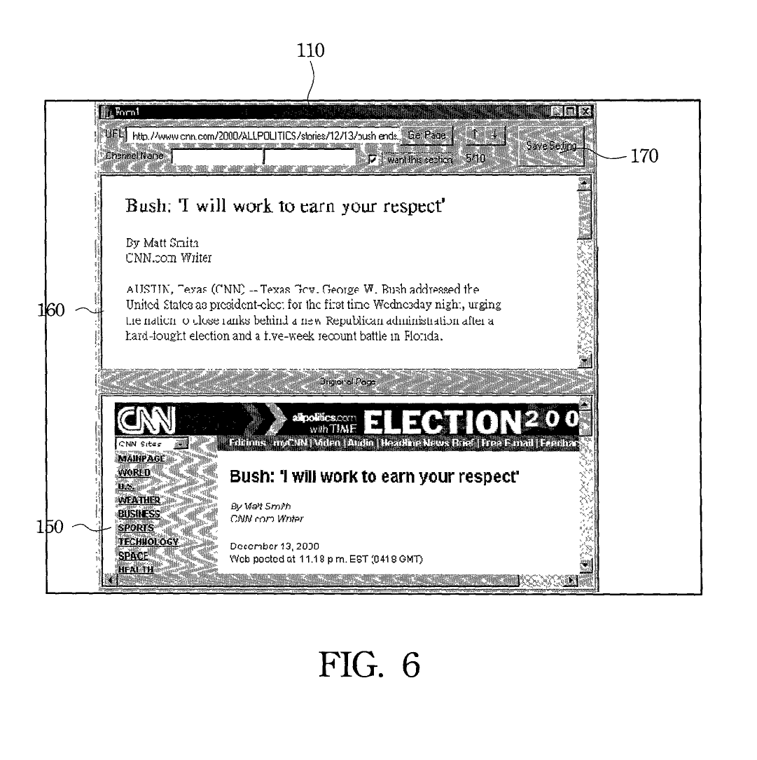

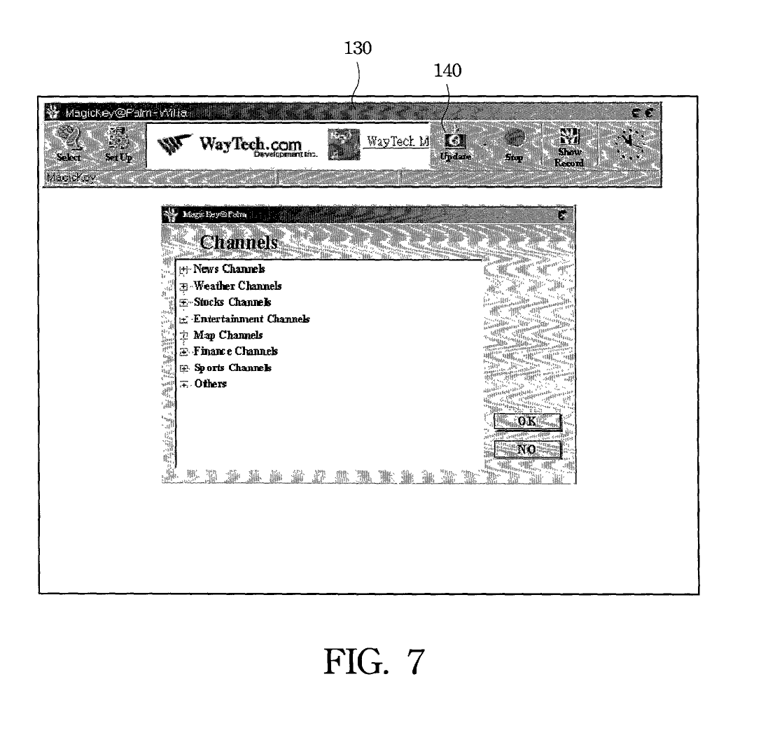

Referring to FIG. 4, FIG. 5, FIG. 6 and FIG. 7, an embodiment of the present invention is illustrated. As shown in FIG. 4, it illustrates an embodiment of the display window 110 of the Web page extracting device 100. The user could input a Web-site address or its domain name, such as “http://www.cnn.com,” to download the Homepage of CNN Web site, wherein the display window 110 includes two main parts, the lower part and the upper one. The lower part is the original Web page window 150 showing the original CNN's Homepage of this embodiment. Meanwhile, the upper part is the content-block window 160 for displaying the contents of one content block of a Web page. As shown in FIG. 4, the content-block window 160 displays a graphic of “CNN.com,” which is one content block of the original CNN's Homepage. Similarly, another content block of the original CNN's Homepage is illustrated in the content-block window 160 of FIG. 5. Moreover, as shown in FIG. 6, if the Web page contents in the original Web page window 150 further include more detailed contents existing in the sub-layer Web pages, the program parsing element 120 will decompose the next page into a plurality of content blocks, supposed the user further click and select one part of the content block in the content-block window 160. Then, one of the content blocks will be displayed in the content-block window 160. Repeat the process described above, users only need to select what he desires to preserve from all of the content blocks of Web pages and at last save in the selection setting 170. Specially, assign a channel name according to the Web page and add the channel name into the Web-site database 130.

Repeat the setting processes, users could record all setting of Web pages, provided by the Web page content providers 20 on the network 10, in their Web-site database 130 of the Web page content extracting device 100 according to their preferences and requirements. Moreover, transmit the Web-site database 130, already set up, to portable data processing gismos 60 by wire or wireless. As shown in FIG. 7, there is a plurality of channels, such as News Channels, Weather Channels, Stock Channels, etc., for choosing in the Web-site database 130 in portable data processing gismos 60. Accordingly, the users of portable data processing gismos 60 could update their net information in the Web-site database 130 by the renewing element 140, accompanying with the connection means coupled with the Internet, instantly and flexibly. More important, users could retrieve the information according to their preferences beyond the limitations of the screen's size and the volume of memories by extracting the desired information from the redundant messages.

To summarize, the present Internet is superior to the conventional art in the aspects of automatic message update, flexible message access, tight connection between e-companies and customers for creating huge opportunity for profit, and enable for digital gismos to retrieve information from the Internet without any limitation. The information transmission efficiency over the cyberspace is also improved.

Although the invention has been described in detail herein with reference to its preferred embodiment, it is to be understood that this description is by way of example only, and is not to be construed in a limiting sense. It is to be further understood that numerous changes in the details of the embodiments of the invention, and additional embodiments of the invention, will be apparent to, and may be made by, persons of ordinary skill in the art having reference to this description. It is contemplated that such changes and additional embodiments are within the spirit and true scope of the invention as claimed below.

We claim:

1. A method for extracting contents of Web pages, the method comprising:
(a) accessing one of the Web pages;
(b) decomposing the Web page into a plurality of content blocks;
(c) selecting at least one of the content blocks; and
(d) saving a setting of the at least one of the content blocks.

2. The method of claim 1, wherein after the step (d) further comprising:
(e) repeating the step (a) through (d) until completing saving the settings of the selected content blocks; and
(f) adding the settings of the selected content blocks into a Web-site database.

3. The method of claim 2, wherein after the step (f) further comprising:
(g) utilizing the settings of the Web-site database to update the selected content blocks over a network.

4. The method of claim 1, wherein the step (b) is carried out by:
decomposing architecture of a code of the Web page into a plurality of program blocks, each the program block of the code is correlative to each the content block of the Web page;
assigning an index corresponding to each the program block; and
saving the indexes.

5. The method of claim 4, wherein the code of the Web page is selected from a group of CGI programs, Active Server Pages, JAVA programs, HTML programs and XML programs.

6. The method of claim 1, wherein the step (a) further comprises to access the Web page over a network.

7. A computer implemented method for automatically parsing codes of Web pages, and extracting contents of the Web pages for a portable data processing device, the method comprising:
under control of a Web page extracting device,
(a) accessing one of the Web pages;
(b) decomposing the Web page into a plurality of content blocks;
(c) selecting at least one of the content blocks;
(d) saving a setting of the at least one of the content blocks;
(e) repeating the step (a) through (d) until completing saving the settings of the selected content blocks;
(f) adding the settings of the selected content blocks into a Web-site database;
(g) transmitting the Web-site database to the portable data processing device;
under control of the portable data processing device,
(h) receiving the Web-site database; and
(i) displaying the selected content blocks.

8. The method of claim 7, wherein the Web page extracting device and the portable data processing device further being coupled with a network.

9. The method of claim 8, wherein after the step (i) further comprising:
utilizing the Web-site database on the Web page extracting device to update the selected content blocks over the network; and
transmitting the updated content blocks to the portable data processing device.

10. The method of claim 8, wherein after the step (i) further comprising:
utilizing the Web-site database on the portable data processing device to update the selected content blocks over the network.

11. The method of claim 7, wherein the portable data processing device is selected from a group of a desktop, a laptop, a palm top, personal digital assistant (PDA), a pocket PC and mobile phone.

12. The method of claim 7, wherein the step (b) is carried out by:
decomposing architecture of the code of the Web page into a plurality of program blocks, each the program block of the code is correlative to each the content block of the Web page;
assigning an index corresponding to each the program block; and
saving the indexes.

13. The method of claim 12, wherein the code of the Web page is selected from a group of CGI programs, Active Server Pages, JAVA programs, HTML programs and XML programs.

14. The method of claim 7, wherein the step (c) further includes to select one of the content blocks of the Web page to look for the details of the one of the content blocks of another Web page.

15. A system for extracting contents of Web pages, the system comprising:
a Web page extracting device, the Web page extracting device is programmed to extract the contents of the Web pages by a method comprising the steps of:
(a) accessing one of the Web pages;
(b) decomposing the Web page into a plurality of content blocks;
(c) selecting at least one of the content blocks;
(d) saving a setting of the at least one of the content blocks;
(e) repeating the step (a) through (d) until completing saving the settings of the selected content blocks;
(f) adding the settings of the selected content blocks into a Web-site database;
(g) transmitting the Web-site database to the portable data processing device; and
a portable data processing device for receiving the Web-site database, and displaying the selected content blocks.

16. The system of claim 15, wherein the Web-site database of the Web page extracting device further includes a renewing element coupled with a network to update the selected content blocks, and transmitting the selected content blocks to the portable data processing device.

17. The system of claim 15, wherein the Web-site database of the portable data processing device further includes a renewing element coupled with a network to update the selected content blocks.

18. The system of claim 15, wherein the portable data processing device is selected from a group of a desktop, a laptop, a palm top, personal digital assistant (PDA), a pocket PC and mobile phone.

19. The system of claim 15, wherein the Web page extracting device further includes a program parsing element for decomposing architecture of codes of the Web pages into a plurality of program blocks, each the program block of the code is correlative to each the content block of the Web page, assigning an index corresponding to each the program block, and saving the indexes.

20. The system of claim 19, wherein the codes of the Web pages are selected from a group of CGI programs, Active Server Pages, JAVA programs, HTML programs and XML programs.

21. A computer program product for automatically parsing codes of Web pages, and extracting contents of the Web pages for a portable data processing device, the computer program product comprising:
a display element for displaying one of the Web pages;
a program parsing element for decomposing the Web page into a plurality of content blocks, selecting at least one of the content blocks, and generating a setting of the at least one of the content blocks; and
a Web-site database for saving the setting of the at least one of the content blocks.

22. The computer program product of claim 21, wherein the Web-site database further includes a renewing element coupled with a network to update the selected content blocks.

23. The computer program product of claim 21, wherein the program parsing element is programmed to decompose the Web page into a plurality of content blocks by a method of decomposing architecture of a code of the Web page into a plurality of program blocks, each the program block of the code is correlative to each the content block of the Web page, assigning an index corresponding to each the program block, and saving the indexes.

24. The computer program product of claim 21, wherein the code of the Web page is selected from a group of CGI programs, Active Server Pages, JAVA programs, HTML programs and XML programs.
